(19) United States
(12) Patent Application Publication
(10) Pub. No.: US 2007/0108789 A1
(43) Pub. Date: May 17, 2007

(54) Vehicle seat

(76) Inventors: Thomas Robert Cowling, Nottingham (GB); Andrew Schoenemann, Belper (GB)

Correspondence Address: LAW OFFICES OF WILLIAM H. HOLT, 12311 HARBOR DRIVE, WOODBRIDGE, VA, 22192, US

(21) Appl. No.: 10/580,910

(22) PCT Filed: Nov. 24, 2004
(86) PCT No.: PCT/GB04/04959

§ 371 Date: May 30, 2006

(30) Foreign Application Priority Data
Nov. 28, 2003 (GB) 0327703.5

(51) Int. Cl. B60N 2/02

(52) U.S. Cl. 296/65.05

(57) ABSTRACT

A seat (10) for use in a vehicle, the seat comprising side plates (45), a seat member (13-16) hingedly connected to a support (12) along its top edge and supported by the side plates, and a front panel (17) hingedly connected to the underside of the front edge of the seat member. In use as a seat, the space below the seat member is enclosed by the side plates and front panel, so that any under-seat equipment is protected. The seat can be swung up to provide substantially unrestricted access to any under-seat equipment. The components (13-16) forming the seat member may be made by extrusion.

This invention relates to a seat for use in a vehicle, particularly but not exclusively where the vehicle forms part of a mass transit or underground train.

There may be equipment mounted underneath such seats, and it may therefore be desirable for the under-seat space to be boxed in. For example, in the case of underground trains, parts of the door-opening mechanism may be installed under the seats. This ensures that such under-seat equipment is not accidentally damaged, for example by being knocked by passengers' luggage; and if the box is substantially waterproof it provides the further benefit that the floor of the vehicle can be washed down without risk of water getting onto or into the equipment. However, such a box makes access to the equipment, for maintenance or replacement, less convenient.

According to the present invention there is provided a seat for use in a vehicle, the seat comprising side members, a seat member hingedly connected to a support along its top edge and supported by the side members, and a front panel hingedly connected to the underside of the front edge of the seat member, so that the space below the seat member is enclosed by the side members and front panel.

Since the seat member is connected to the support by a hinge, it can be raised up, and the front panel raised with it and pivoted so as to lie underneath the seat member, so as to provide comparatively unrestricted access to the space below the seat member.

Preferably the front panel locates onto a locating member attached to the floor of the vehicle, and it may be secured to the locating member. The locating member may define a slot into which the bottom edge of the front panel fits, or vice versa. Preferably the front panel is sealed to the locating member, for example by a sealing strip along the bottom edge of the front panel. And preferably both the hinge connecting the front panel to the seat member, and the hinge connecting the seat member to the support, are provided with seals. Similarly, seals are preferably provided between the seat member and the side members, and between the side members and the front panel, so that the space below the seat member is enclosed in a substantially watertight fashion.

The side members are preferably panels. They may be connected to the seat member, for example by another hinge, but more typically would be fixed to the floor of the vehicle. The support to which the seat member is connected might be a transverse partition within the vehicle, or might be the wall of the vehicle.

Preferably the seat member includes a backrest, and is preferably padded on its upper surface for comfort. It may also incorporate arm rests.

Preferably the seat member, and the front panel, and the hinge connection between them comprise extruded elements. The hinge connection between the seat member and the support is preferably also formed of extruded elements.

The invention will now be further and more particularly described, by way of example only, and with reference to the accompanying drawings in which:

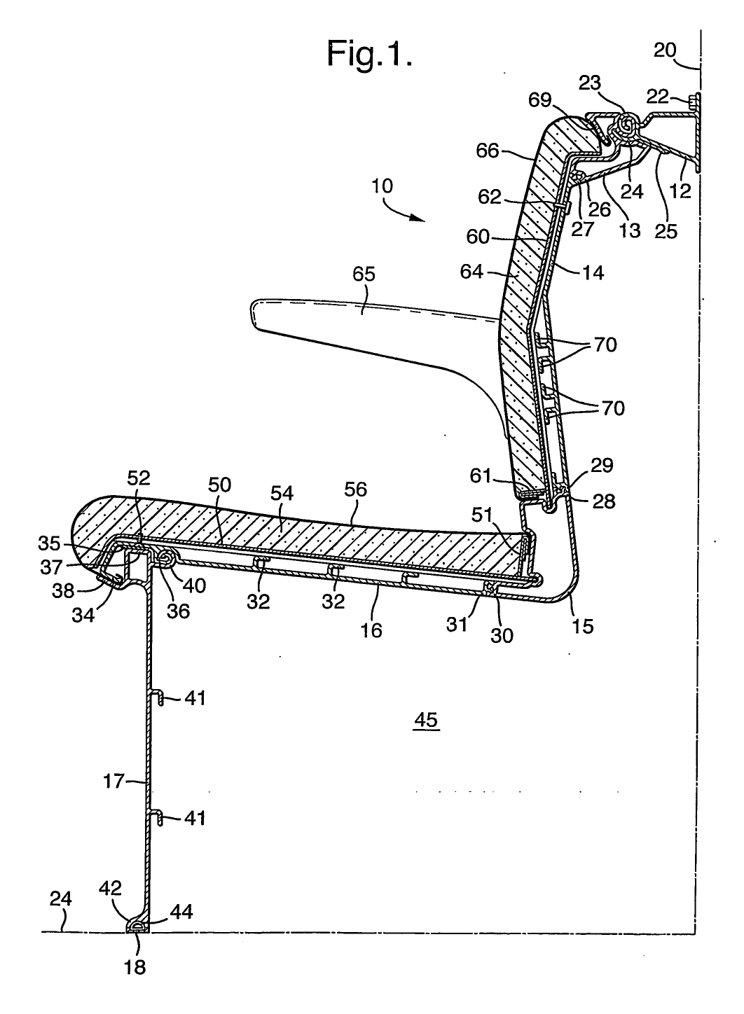

FIG. 1 shows a sectional view, in a vertical plane, through a bench seat of the invention; and

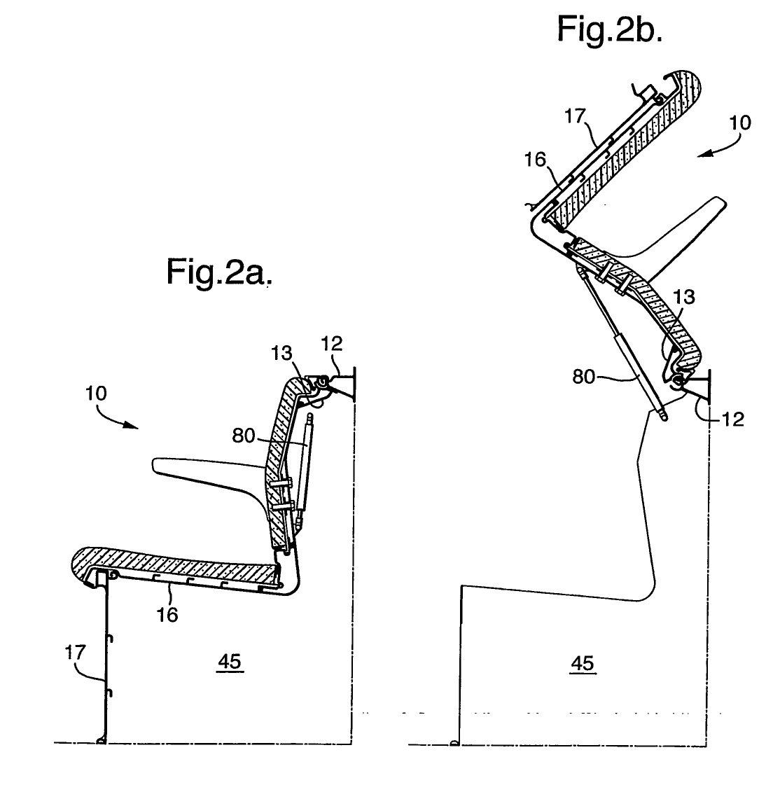

FIGS. 2a and 2b show views corresponding to that of FIG. 1 to illustrate raising the seat.

Referring to FIG. 1, a bench seat 10 is shown for use in an underground train, attached to a wall of the vehicle. The structural components of the bench seat 10 are formed from interlocked aluminium extrusions 12-17, as follows. A support rail 12 is attached to the wall 20 by bolts 22. A top rail 13 forms the top of the seat back, and is hingedly connected to the support rail 12. A back plate 14 is attached along its top edge to the top rail 13, and is attached along its bottom edge to a hollow corner rail 15. The front edge of the hollow corner rail 15 is connected to a seat panel 16. And a front panel 17 is hingedly connected to the underside of the seat panel 16 near its front edge. The bottom edge of the front panel 17 locates on a base strip 18 attached to the floor 24.

Considering these structural components in more detail, the support rail 12 has two opposed arcuate projections 23 and 24 along its outer face; these are each part-cylindrical, and concentric, but the radii of curvature are different. A strip of rubber 25 is attached along the lower face of the support rail 12. The top rail 13 defines two arcuate slots into which the projections 23 and 24 engage; it also defines a flat surface which rests against the rubber strip 25; and it defines a pair of ridges and slots 26 along its bottom edge which mate with a corresponding pair of ridges and slots 27 along the top edge of the back plate 14. Similarly, the corner rail 15 defines a pair of ridges and slots 28 along its top edge which mate with a corresponding pair of ridges and slots 29 along the bottom edge of the back plate 14, and defines a pair of ridges and slots 30 along its front edge which mate with a corresponding pair of ridges and slots 31 along the back edge of the seat panel 16. The seat panel 16 has three longitudinal L-shaped flanges 32 to enhance its rigidity. Along its front edge the seat panel 16 curves downwardly and has a downward-facing inclined flange 34, alongside which is a flat area on which is a rubber sealing strip 35, and on its lower surface is a projection defining a C-shaped slot 36. The front panel 17 has a forwardly-projecting box flange 37 which rests against the sealing strip 35, and an inclined forwardly-projecting flange 38 which rests against the flange 34; it also has a backwardly-projecting C-shaped flange 40 which locates in the slot 36. It has two longitudinal L-shaped flanges 41 to enhance its rigidity, and a base flange 42 resting on a rubber seal 44 on the base strip 18.

These structural components 12-17 are assembled by sliding the ridges or projections into the slots or grooves. The pairs of ridges and slots 26 and 27, 28 and 29, 30 and 31 provide substantially rigid joints, and after assembling these joints they are spot welded, and a bead of sealant is applied along the front edge. The projections 23 and 24 engaging with the slots at the back of the top rail 13 allows the top rail 13 (and consequently the rest of the seat) to hinge about the support rail 12 through an angle of just over 90°. Similarly the C-shaped flange 40 in the slot 36 enables the front panel 17 to hinge about the seat panel 16 through an angle of about 75°. The rubber strips 25 and 35 ensure that the hinged joints are also watertight (when the seat is in the position shown). The front panel 17 may also be provided with a locking mechanism (not shown) by which it is secured to the base strip 18.

At each end the seat 10 is provided with a support plate 45 with a sealing strip (not shown) along its outer edge, the support plate 45 being fixed to the wall 20 and floor 24 and abutting the rear and under surfaces of the structural components 12-17 when in the position shown. The support plate 45 may be of cast aluminium. It provides support to the seat panel 16 in carrying the weight of the passengers. The flanges 41 on the front panel 17 are cut off 25 mm from each end, so as to present a flat surface up against the support plate 45.

The seat panel 16 and the back plate 14 are provided with upholstery. Considering the seat panel 16, each passenger position along the bench seat 10 is upholstered separately, being provided with a rectangular steel tray 50 with ridges or corrugations in its base, upstanding walls along the sides with slots at their base, and an upstanding wall along the back with a turned-over edge 51. This tray 50 rests on the seat panel 16 with its front edge secured by a screw 52, and a projecting part of its base locating in a groove in the corner rail 15. The tray 50 is covered by a foam pad 54, and this is covered with a fabric cover 56 secured by means of plastic J-strips sewn onto the fabric, these engaging with the turned-over edge 51 at the back, with the slots along the side walls, and with the flange 34 along the front edge of the seat panel 16.

Similarly each passenger position is provided with a steel tray 60 to fit the back plate 14, the steel tray 60 having a flange with a turned over edge 61 at its bottom, and slots along the side edges. The lower half of each tray 60 tapers slightly so there is a tapered gap between adjacent trays to fit an arm rest 65. The tray 60 is placed up against the back plate 14, with a projecting part of its base locating in a groove in the corner rail 15, and secured by a screw 62 near the top. The tray 60 is covered by a foam pad 64, and this is covered with a fabric cover 66 secured by means of J-strips, these engaging with the turned-over edge 61 at the bottom, with the slots along the sides, and with a flange 69 on the top rail 13.

The arm rest 65 has a projecting part which fits in the tapered gap in between adjacent trays 60, and is attached to the back plate 14 by bolts (not shown) passing through holes drilled between adjacent L-shaped flanges 70 on the back plate 14.

The upstanding walls on the trays 50 are separated only by two layers of fabric 56, so there is substantially no gap into which rubbish or hazardous objects may be pushed.

The seat structure is substantially watertight because of the rubber sealing strips 25 and 35 adjacent to the hinged joints, the seal around the support plate 45, and the seal 44 along the bottom of the front panel 17, so that dust and litter are kept out of the under-seat space during normal operations, and water is kept out during cleaning operations.

Referring now to FIG. 2a, a gas strut 80 is provided between pivot points on the back of the seat 10 and the support plate 45. When maintenance on equipment in the under-seat space is required, the locking mechanism would be release, and as shown in FIG. 2b the seat 10 can be swung up, pivoting about the hinge between the support rail 12 and the top rail 13. As it does so, the front panel 17 swings down so as to lie up against the underside of the seat panel 16. This provide substantially unrestricted access to the under-seat space.

It will be appreciated that a seat may be modified in various ways, while remaining within the scope of the invention. The seat may be of various different lengths, typically being designed to carry between one and six seated passengers. For longer seats, for example to accommodate twelve seated passengers, it would be desirable to provide one or more intermediate supports to the seat panel 16 along its length. Such intermediate supports may be of any convenient shape, as they do not need to seal to the rear surface of the seat 10, and would typically be arranged in such positions as not to impede access to under-seat equipment.

Where upholstery is provided, it may differ from that shown, and for example might include springs in place of, or in addition to, foam padding. The trays carrying the upholstery might differ from those shown, and might for example be secured against sliding forwards by abutting an upward flange on the front edge of the seat panel 16 instead of or in addition to the securing screws 52. Alternatively the upholstery might be replaced by a moulded plastic bench, or individual moulded plastic seats attached for example by bolts to the seat panel 16 and the back panel 14; such plastic seats might be of polyethylene.

It will also be appreciated that, where the seat structure is made of extruded components, these may differ from those described. For example the components defining the rigid part of the seat, i.e. components 13-16, might instead be a single integral extrusion, or might be formed of a different number of extrusions, for example components 13 and 14 might be integral with each other, and components 15 and 16 might be integral with each other.

As another modification, the front panel 17 may be of a different height to that described above, and might rest on a sill or wall attached to the floor (or integral with the floor), rather than resting on the floor itself.

1. A seat for use in a vehicle, the seat comprising side members, a seat member hingedly connected to a support along its top edge and supported by the side members, and a front panel hingedly connected to the underside of the front edge of the seat member, so that the space below the seat member is enclosed by the side members and front panel, and wherein the seat member, the front panel, and the hinge connection between them comprise extruded elements.

2. A seat as claimed in claim 1 wherein the front panel locates onto a locating member attached to the floor of the vehicle.

3. A seat as claimed in claim 2 wherein a seal is provided between the front panel and the locating member.

4. A seat as claimed in claim 3 wherein both the hinge connecting the front panel to the seat member, and the hinge connecting the seat member to the support, are provided with seals.

5. A seat as claimed in claim 1 wherein the support to which the seat member is connected is a wall of the vehicle.

6. A seat as claimed is claim 1 wherein the seat member comprises an extruded element with longitudinal strenthening ribs.1

7. A seat as claimed in claim 1 wherein hinge connection between the seat member and the support is formed of extruded elements.

8. A seat as claimed in claim 1 incorporating padding, wherein the padding is supported by trays with sidewalls, so there is substantially no gap between adjacent areas of padding.
